(19) United States
(12) Patent Application Publication
(10) Pub. No.: US 2007/0268414 A1
(43) Pub. Date: Nov. 22, 2007

(54) METHOD AND SYSTEM FOR DISTRIBUTING PVR FUNCTIONALITIES

(76) Inventor: Ming-Tso Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/419,503

(22) Filed: May 21, 2006

(51) Int. Cl. H04N 5/44

(52) U.S. Cl. 348/725

(57) ABSTRACT

A system for distributing PVR functionalities is disclosed. The system includes: a server device, having PVR functionalities, for receiving a multimedia data and performing at least a specific PVR function on the multimedia data in response to a specific request signal; and a client device, coupled to the server device, for playing the multimedia data and for sending the specific request signal to request the server device to perform the specific PVR function.

### BACKGROUND OF THE INVENTION

1. Field of the Invention

The present invention relates to performing PVR functions, and more particularly, to a method and system that can distribute PVR functionalities from one device to another.

2. Description of the Prior Art

Digital television systems receive data and buffer the data in a storage, which is accessed during playback modes. Therefore, when data is being viewed on a digital system there is a slight time delay between the time data is received and the time it is viewed. This ‘time shift’ between record and playback processes allows for a variety of processes to be carried out on the data.

Trick mode operations involve manipulation of data, such as freeze frame, scheduled recording, and management of data files. These operations are known as PVR functions, and are typically limited to the server device where a data signal is received. If the data signal is transmitted to another device, i.e. a client device, a user can only view the data signal as it is transmitted, and cannot perform said PVR functions on the data signal. Therefore, a novel scheme is needed to distribute PVR functionalities from the server device to the client device to meet user's demands.

### SUMMARY OF THE INVENTION

It is therefore one aim of the present invention to provide a system that can distribute PVR functionalities to a client device, wherein a user can perform trick mode operations at the client device.

Briefly described, a system for distributing PVR functionalities comprises: a server device, having PVR functionalities, for receiving a multimedia data and performing at least a specific PVR function on the multimedia data in response to a specific request signal; and a client device, coupled to the server device, for playing the multimedia data and for sending the specific request signal to request the server device to perform the specific PVR function.

A method for distributing PVR functionalities is also disclosed. The method comprises: at a first location, receiving a multimedia data and performing at least a specific PVR function on the multimedia data in response to a specific request signal; at a second location, playing the multimedia data and generating a specific request signal; and sending the specific request signal from the second location to the first location for requesting the specific PVR function performed on the multimedia data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a system for distributing PVR functionalities according to an embodiment of the present invention.

### DETAILED DESCRIPTION

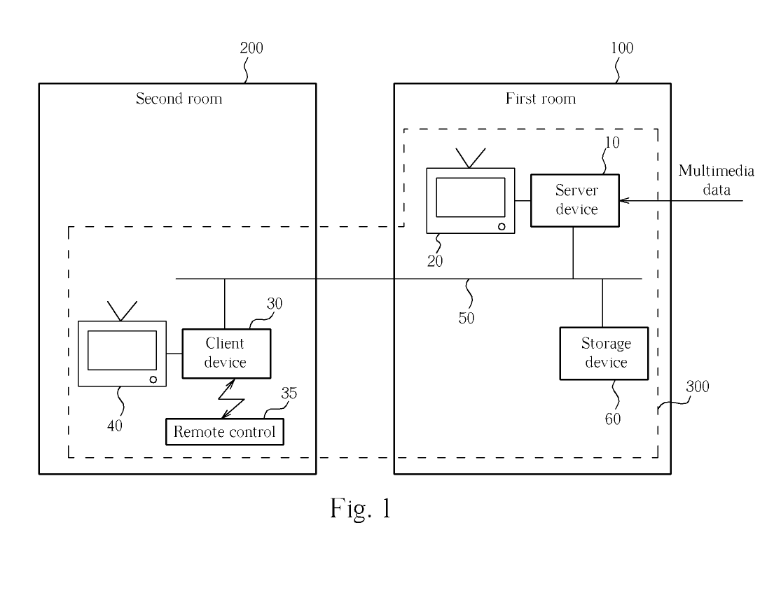

Please refer to FIG. 1. FIG. 1 is a diagram of a system 300 for distributing PVR functionalities according to an embodiment of the present invention. In this embodiment, the system 300 comprises a server device 10, a first playing device 20, a client device 30, a second playing device 40, a Home Networking LAN 50, and a storage device 60. The server device 10 is responsible for receiving a multimedia data signal from a multimedia source (e.g. a TV program provider). This multimedia data signal may be a broadcast signal, a UPnP signal or a video on demand (VOD) signal. The server device 10 has PVR functionality. In FIG. 1 the server device 10 is contained in a first room 100. The client device 30 is contained in a second room 200. In this embodiment, the client device 30 does not have PVR functionality. The server device 10 and the client device 30 are connected by means of the Home Networking LAN 50. It should be noted that any communications network service capable of linking the server device 10 and the client device 30 can be utilized as the Home Networking LAN 50. The server device 10 and the client device 30 are respectively coupled to the first playing device 20 and the second playing device 40 for playing the multimedia data. In FIG. 1 the first playing device 20 and the second playing device 40 are television monitors, however, please note that this is not a limitation of the present invention and they can be any devices capable of playing multimedia data.

The server device 10 further comprises an electronic program guide (EPG), which contains information relating to the received multimedia data. For example, if the multimedia data is a broadcast television signal, such as a DTV signal, then the EPG will contain information relating to the television programs scheduled for that day. Conventionally, a user will browse the EPG at the server device 10 for performing the PVR functions. In this embodiment, the server device 10 will send the EPG to the client device 30 utilizing UPnP protocol. As the client device 30 also supports the UPnP protocol, the client device 30 can receive and display the EPG. A user can therefore browse the EPG at the client device 30 and select an EPG item from the EPG displayed on the second playing device 40. The user can further utilize a remote control 35 to select a PVR function they wish to perform on the selected EPG item. For example, the remote control 35 has a button labeled as ‘RECORD’ for activating a scheduled recording function for a specific selected EPG item (i.e. a selected TV program), and another button labeled as ‘Time Shift’ for activating a time shift function for a specific selected EPG item (i.e. a selected TV program). This selection activates a request signal, which is then sent to the server device 10 via the Home Networking LAN 50. In this embodiment, a Simple Object Access Protocol (SOAP) is utilized to transmit the request signal; in other words, the request signal is sent as a SOAP signal, with the selected EPG item as the parameter. The server device 10 utilizes the SOAP signal to send the requested program to the client device 30, but also sends the signal to a storage device 60. Therefore, when a user wishes to perform trick mode operations on the streamed data, the request signal sent by the client device 30 will instruct the server device 10 to access the content in the storage device 60, thereby supporting the trick mode operations. In this way, the client device 30 can support PVR functionalities. Please note that since operation of these PVR functionalities mentioned in this disclosure is well known to those skilled in this art, further description is omitted for brevity.

The system 300 can also utilize this feature to perform file management at the client device 30. As the EPG is sent to the client device 30 utilizing UPnP protocol, the client device 30 can manage these files stored in the storage device 60 utilizing SOAP methods. In order to distinguish these methods from other UPnP allowed operations, the client device 30 can be configured to distinguish between PVR files and ordinary UPnP media files.

Please note that the configuration shown in FIG. 1 is only for illustrative purposes, and is not meant to be taken as a limitation of the present invention. For example, in another embodiment, the storage device 60 is embedded in the server device 10 for saving the bandwidth occupation of the Home Networking LAN 50. In addition, these PVR functionalities mentioned above, i.e. the scheduled recording operation, the time shift operation, and the PVR media management, are for illustrative purposes. The disclosed PVR functionality distribution scheme can be applied to any PVR functionalities. Similarly, the present invention is not limited to the aforementioned signal transfer protocols; in other words, assuming the same result is substantially achieved, the present invention is allowed to adopt other signal transfer protocols to implement the disclosed PVR functionality distribution scheme. Moreover, in the above embodiment, the client device 30 is defined to have no PVR functionalities. However, this is not meant to be a limitation of the present invention. For example, in a case where the client device 30 originally supports a first PVR function but not a second PVR function, the client device 30 can send a request signal to the server device 10 for requesting execution of the second PVR function. The same objective of distributing PVR functionalities is achieved. All of these alternative designs fall in the scope of the present invention.

The present invention enables PVR functionalities to be distributed to any device connected by a home networking connection. A user can view a multimedia data on a device in a separate location from a server device, and still be able to perform PVR operations on the multimedia data. This greatly increases the flexibility of a digital server system, and aids a user both in terms of convenience and economy.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for distributing PVR functionalities, the system comprising:
a server device, having PVR functionalities, for receiving a multimedia data and performing at least a specific PVR function on the multimedia data in response to a specific request signal; and
a client device, coupled to the server device, for playing the multimedia data and for sending the specific request signal to request the server device to perform the specific PVR function.

2. The system of claim 1, wherein a resultant multimedia data generated by the specific PVR function is transmitted to the client device by the server device, and then the client device plays the resultant multimedia data.

3. The system of claim 1, wherein the multimedia data is a TV program data, the server device further delivers an electronic program guide (EPG) of the TV program data to the client device, and the client device references the EPG to send the specific request signal.

4. The system of claim 3, wherein the client device sends the specific request signal utilizing a Simple Object Access Protocol (SOAP).

5. The system of claim 4, wherein an EPG item selected at the client device is utilized as a parameter for the specific request signal sent to the server device.

6. The system of claim 2, wherein the specific PVR function requested by the specific request signal is a scheduled recording operation or a time shift operation.

7. The system of claim 1, wherein the specific PVR function requested by the specific request signal is a PVR media management operation.

8. The system of claim 1, wherein the specific request signal is sent in response to a user command.

9. The system of claim 1, wherein the client device has no PVR functionality.

10. A method for distributing PVR functionalities, the method comprising:
at a first location, receiving a multimedia data and performing at least a specific PVR function on the multimedia data in response to a specific request signal;
at a second location, playing the multimedia data and generating a specific request signal; and
sending the specific request signal from the second location to the first location for requesting the specific PVR function performed on the multimedia data.

11. The method of claim 10, wherein the step of requesting the specific PVR function performed on the multimedia data further comprises:
sending a resultant multimedia data from the first location to the second location; and
playing the resultant multimedia data at the second location.

12. The method of claim 10, wherein the multimedia data is a TV program data, the step of receiving the multimedia data further comprises delivering an electronic program guide (EPG) to the second location, and the step of generating the specific request signal further comprises:
referencing the EPG to generate the specific request signal.

13. The method of claim 12, wherein the specific request signal is sent utilizing a Simple Object Access Protocol (SOAP).

14. The method of claim 12, wherein the step of referencing the EPG to generate the specific request signal further comprises:
selecting a specific EPG item as a parameter for the specific request signal.

15. The method of claim 11, wherein the specific PVR function requested by the specific request signal is a scheduled recording operation or a time shift operation.

16. The method of claim 10, wherein the specific PVR function requested by the specific request signal is a PVR media management operation.

17. The method of claim 10, wherein the specific request signal is sent in response to a user command.

18. The method of claim 10, wherein no PVR function can be performed at the second location.
